(19) United States
(12) Patent Application Publication
(10) Pub. No.: US 2010/0144819 A1
(43) Pub. Date: Jun. 10, 2010

(54) Synergistic Methods for Control of Pests

(75) Inventors: Ian Francis, Goodoowindi (AU); Dugald North, Enoggera (AU)

Correspondence Address: PATENT ADMINISTRATOR;FMC CORPORATION, 1735 MARKET STREET, PHILADELPHIA, PA, 19103, US

(73) Assignee: FMC AUSTRALASIA PTY. LTD., Murarrie (AU)

(21) Appl. No.: 12/628,371

(22) Filed: Dec. 1, 2009

Related U.S. Application Data
(60) Provisional application No. 61/201,266, filed on Dec. 9, 2008.

(51) Int. Cl. A01N 43/56; A01P 7/04

(52) U.S. Cl. 514/407

(57) ABSTRACT

The present invention provides a method for the synergistic control of insect pests, such as cockroaches and spiders, which comprises applying to a locus where insect pest control is needed or expected to be needed a synergistically effective amount of a combination of bifenthrin and fipronil.

This application claims the benefit of U.S. Provisional Application No. 61/201,266 filed Dec. 9, 2008.

### FIELD OF THE INVENTION

The present invention relates to a method for the control of cockroaches and spiders employing a synergistic mixture of bifenthrin and fipronil.

### BACKGROUND OF THE INVENTION

Cockroaches and spiders are household pests that can appear in human and animal living environments at any place and at any time. They generally contaminate food and articles subjecting humans and animals to threats of bacteria and viruses.

Pesticidal compositions have commonly been used to control these pests. A concern in developing a pesticidal composition to control these pests is the amount of the pesticide needed to effectively control the pest populations. Ecological and cost benefits would be realized if new pesticidal compositions for controlling cockroaches and spiders could provide effective control at use rates lower than current commercial rates.

### SUMMARY OF THE INVENTION

It has now been discovered that certain combinations of bifenthrin and fipronil provide synergistic control of cockroaches and spiders. Accordingly, the method of this invention comprises applying to a locus where cockroach and/or spider control is needed or expected to be needed a synergistically effective amount of a combination of bifenthrin and fipronil.

### DETAILED DESCRIPTION OF THE INVENTION

It has now been discovered that certain combinations of bifenthrin and fipronil exhibit unexpectedly beneficial pesticidal activity, when applied, to cockroaches or spiders. A pesticidal composition comprising bifenthrin and fipronil significantly improved knockdown and mortality characteristics when applied to cockroaches or spiders, at significantly lower use rates when compared to the use of such individual pesticides alone.

A preferred embodiment of the present invention is a method for controlling cockroaches and/or spiders by applying a synergistically pesticidally effective amount of a composition comprised of bifenthrin and fipronil to a locus where cockroach and/or spider control is needed or expected to be needed, for example, a pest-infested structure, a structure that is expected to be pest-infested, or a location adjacent to these structures.

Another embodiment of the present invention is a method for the control of cockroaches and/or spiders which comprises applying a synergistically effective amount of bifenthrin and a synergistically effective amount of fipronil either together or sequentially; in any order, to a locus where cockroach and/or spider control is needed or expected to be needed wherein the applied weight ratio of bifenthrin to fipronil is from about 10:1 to about 1:1. The most preferred weight ratio of bifenthrin to fipronil is from about 2:1 to about 1:1.

The method of the present invention is particularly useful in the control of cockroaches such as, but not limited to, American cockroach and German cockroach. The method of the present invention is also useful in the control of spiders such as, but not limited to, the black house spider.

The synergistically effective amount of the combination of bifenthrin and fipronil can vary according to the weather conditions, soil conditions, mode of application, application timing and the like. In general, a synergistic effect may be achieved at application rates of from about 100 ppm (parts per million) to about 1000 ppm or from about 0.1 g ai/L to about 1.0 g ai/L atm application rate of 1 L/10 m² of bifenthrin in combination with from about 10 ppm to about 500 ppm or from about 0.01 g ai/L to about 0.5 g ai/L, at an application rate of 1 L/10 m² of fipronil.

The presence of a synergistic effect between the two active ingredients is established with the aid of the Colby equation (see Colby, S. R., “Calculating Synergistic and Antagonistic Responses of Herbicide Combinations”, Weeds 1967, 15, pg 20-22): E=X+Y−(XY/100).

Using the method of Colby, the presence of asynergistic interaction between two active ingredients is established by first calculating the expected activity, ‘E’, of the mixture based on activities of the two components applied alone. If ‘E’ is lower than the observed activity, synergy is present. In the equation above, ‘X’ is the percentage control observed when bifenthrin applied alone at rate ‘x’. The ‘Y’ term is percentage control observed when fipronil applied alone at rate ‘y’. The equation calculates ‘E’, the expected activity of the mixture of ‘X’ at rate ‘x’ with ‘Y’ at rate ‘y’ if their effects are strictly additive and no interaction has occurred.

As is employed herein, the term “bifenthfin” means 2-methylbiphenyl-3-ylmethyl (Z)-(1RS)-cis-3-(2-chloro-3,3,3-trifluoroprop-1-enyl)-2,2-dimethylcyclopropanecarboxylate, CAS Registry Number 82657-04-3. The term “fipronil” means (5-amino-[2,6-dichloro-4(trifluoromethyl)phenyl]-4-[(1R,S)-(trifluoromethyl)sulfinyl]-1H-pyrazole-3-carbonitrile, CAS Registry Number 120068-37-3. The term “knockdown” refers to the quick, short-term immobilization of cockroaches and/or spiders and the term “mortality” refers to the death of the cockroaches and/or spiders.

The method of the present invention may employ the pesticidal active ingredients (ai's) in many forms and are often most conveniently prepared in aqueous form immediately prior to use. One method of preparing such a composition is referred tows “tank mixing” in which the active ingredients in their commercially available form, either with or without other additives, are mixed together by the user in a quantity of water.

In addition to tank mixing immediately prior to use the compositions of the present invention may be formulated into a more concentrated primary composition which is diluted with water or other diluent before use. Examples of such formulations of pesticides that are or can be dispensed in an aqueous medium prior to application are also within the scope of the present invention, for example, granules of relatively large particle size (for example, 8/16 or 4/8 US Mesh), micro-emulsions, suspension concentrates, emulsifiable concentrates, wettable powders, water-soluble or water-dispersible granules, powdery dusts, capsule suspensions, emulsifiable granules, aqueous emulsions, solutions or combinations thereof, depending on the desired mode of application to the areas in which control of cockroaches and/or spiders is desired. These formulations may contain as little as 0.1%, 0.2% or 0.5% to as much as 95% or more by weight of the total of the two pesticides. Such compositions may comprise a surface active, agent in addition to the active ingredients and examples of such compositions are set forth below.

The pesticidal composition can be in the form of a dispersible solution which comprises the pesticides dissolved in a water-miscible solvent with the addition of a dispersing agent. Alternatively it can comprise the pesticides in the form of a finely ground powder in association with a dispersing agent and intimately mixed with water to give a paste or cream which can if desired be added to an emulsion of oil in water to give a dispersion of the two pesticides in an aqueous oil emulsion.

Alternatively, the pesticidal composition can be the form of water-soluble or water-dispersible granules that, disperse readily in water or other dispersant. Water-soluble or water-dispersible granules normally are prepared to contain about 5-80% of the pesticides, depending on the absorbency of the carrier, and usually also contain a wetting, dispersing or emulsifying agent to facilitate dispersion and may contain a preservative. Typical carriers for water-soluble or water-dispersible granules include Fuller's earth, natural clays, silicas, and other highly absorbent, readily wet inorganic diluents. For example, a useful water-soluble or water-dispersible granule formulation contains 26.71 parts of the pesticides, 30.90 parts of ammonium sulfate, 30.89 parts of continental clay, 10.00 parts of sodium lignosulfonate as a dispersant, 1.00 part of sodium dioctylsuccinate as a wetting agent and 0.50 part of citric acid as a preservative. The mixture is milled, diluted with water to form a paste and the paste is extruded and dried to produce granules.

Other alternatives that may be employed are dusts which are free flowing admixtures of the pesticides with finely divided solids such as talc, natural clays, kieselguhr, flours such as walnut shell and cottonseed flours; and other organic and inorganic solids which act as dispersants and carriers for the pesticides. These finely divided solids have an average particle size of less than about 50 microns. A typical dust formulation useful herein is one containing 1.0 part or less of the pesticidal compounds and 99.0 parts of talc.

Also useful formulations for the pesticidal compositions of the present invention are wettable powders in the form of finely divided particles that disperse readily in water or other dispersant. The wettable powder is ultimately applied to the locus where pest control is needed either as a dry dust or as an emulsion in water or other liquid. Typical carriers for wettable powders include Fuller's earth, kaolin clays, silicas, and other highly absorbent, readily wet inorganic diluents. Wettable powders are prepared to contain about 5-80% of the pesticides, depending on the absorbency of the carrier, and usually also contain a small amount of a wetting, dispersing or emulsifying agent to facilitate dispersion. For example, a useful wettable powder formulation contains 80.0 parts of the pesticidal compounds, 17.9 parts of Palmetto clay, and 1.0 part of sodium lignosulfonate and 0.3 part of sulfonated aliphatic polyester as wetting agents. Additional wetting agents and/or oils will frequently be added to a tank mix to facilitate dispersion on the target site.

Other useful formulations for the pesticidal compositions employed in the practice of the present invention are emulsifiable concentrates (ECs) which are homogeneous liquid compositions dispersible in water or other dispersant, and may consist entirely of the pesticidal compounds and a liquid or solid emulsifying agent, or may also contain a liquid carrier, such as xylene, heavy aromatic naphthas, isophorone, or other non-volatile organic solvents. For pesticidal application these concentrates are dispersed in water or other liquid carriers and applied as a spray to the area to be treated. The percentage by weight of the pesticidal compounds may vary according to the manner in which the composition is to be applied, but in general comprises 0.5 to 95% of the pesticidal compounds by weight of the total composition.

Suspension concentrate formulations may also be employed. These are similar to ECs, except that the pesticidal compounds are suspended in a liquid carrier, generally water. Suspension concentrates, like ECs, may include a small amount of a surfactant, and will typically contain the pesticidal compounds in the range of 0.5 to 95%, frequently from 10 to 50%, by weight of the total composition. For example, a useful suspension concentrate formulation contains 22.0 parts of the pesticidal compounds, 2.6 parts of an ethoxylated/propoxylated block copolymer surfactant, 0.4 part phosphate ester surfactant, 0.8 part thickening agent, 6.0 parts antifreeze agent, 0.1 antifoam agent, 0.05 part anti-bactericide and 44.0 parts distilled water. For pesticidal application, suspension concentrates may be diluted in water or other liquid vehicle, and are normally applied as a spray to the area to be treated.

Other useful formulations include suspensions of the pesticidal compounds in a relatively non-volatile solvent such as water, corn oil, kerosene, propylene glycol, or other suitable solvents.

Still other useful formulations for these pesticidal compositions include simple solutions of the pesticides in a solvent in which it is completely soluble at the desired concentration, such as acetone, alkylated naphthalenes, xylene, or other organic solvents. Pressurized sprays, typically aerosols wherein the pesticides are dispersed in finely divided form as a result of vaporization of a low-boiling dispersant solvent carrier may also be used.

Another useful formulation for the pesticidal compositions of the present invention is micro-encapsulation. This method of formulation is a process in which either one or both of the pesticidal compounds may be encapsulated in a shell of polyurea, polyimide or amide-urea copolymer as disclosed in EP 0792100 B1 and U.S. Pat. No. 5,583,090.

In some circumstances it may be desirable to combine two types of formulation e.g. one of the pesticidal compounds is used as an emulsifiable concentrate and the second pesticidal compound is dispersed as a powder in this concentrate.

The concentration of the active pesticides (when used as the sole active components) in a composition for direct application to the desired site by conventional methods is preferably within the range of 0.001 to 10% by weight of the composition, especially 0.005 to 5% by weight but more concentrated compositions containing up to 40% may be desirable.

Typical wetting, dispersing or emulsifying agents that may be used in the compositions of the present invention include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

The following examples further illustrate the present invention, but, of course, should not be construed as in any way limiting its scope. The examples set forth certain biological data illustrating the efficacy of the compositions of the present invention in controlling cockroaches and/or spiders.

### Example 1

### Test 1 to Determine Cockroach Mortality Rates by Applications of Combinations of Bifenthrin and Fipronil

The compositions of the present invention were tested for German cockroach (Blatella germanica) activity in the following manner.

Test solutions were made by dissolving technical grade bifenthrin and fipronil in acetone to provide appropriate rates of application of bifenthrin and fipronil alone, as well as combinations of bifenthrin and fipronil. The active ingredient concentrations tested were from 50 parts per million (0.05 mg of active ingredient/mL or 0.05 g/L) to 500 parts per million (0.5 mg of active ingredient/mL or 0.5 g/L), four replicates per rate. In a fume cabinet, one milliliter of a test solution was applied to a 9 cm Whatman® 2 qualitative filter paper using a calibrated pipette. The application started at the center of the filter paper with individual drops being applied in an outward circular motion so that the entire filter paper was uniformly treated. Acetone only (one mL) was applied in the same manner to provide an untreated control (UTC). The treated filter papers were allowed to dry for two hours. The dried, treated or untreated filter paper was placed into a plastic Petri dish and ten late instar, healthy and active German cockroaches (Blattella germanica) were momentarily immobilized using carbon dioxide and then placed onto the filter paper. The lid of each Petri dish was put on to contain the cockroaches. The Petri dishes were maintained at a temperature of 25° C. to 30° C. at ambient relative humidity out of direct sunlight. German cockroach mortality was assessed after 24 hours by counting the number of alive and the number of knocked down/dead cockroaches. The results are presented in Table 1 below:

TABLE 1
Mortality of Cockroach by Application of Combinations of Bifenthrin and Fipronil

| | | Rate of | Mortality | Mortality | Mortality | Mortality | % | % |
|---|---|---|---|---|---|---|---|---|
| | Rate of Appln. | Appln. | Rep 1 | Rep 2 | Rep 3 | Rep 4 | Expected | Observed |
| Treatment | (ppm) | (mg/mL) | dead/alive | dead/alive | dead/alive | dead/alive | Control | Control |
| UTC | 0 | 0 | 0/10 | 0/10 | 0/10 | 0/10 | — | 0 |
| A | 100 | 0.1 | 0/10 | 0/10 | 0/10 | 1/9 | — | 2.5 |
| Bifenthrin | 250 | 0.25 | 9/1 | 9/1 | 9/1 | 9/1 | — | 90 |
| | 500 | 0.5 | 10/0 | 10/0 | 10/0 | 9/1 | — | 97.5 |
| UTC | 0 | 0 | 0/10 | 0/10 | 0/10 | 0/10 | — | 0 |
| B | 50 | 0.05 | 7/3 | 1/9 | 0/10 | 1/9 | — | 22.5 |
| Fipronil | 100 | 0.1 | 6/4 | 3/7 | 4/6 | 4/6 | — | 42.5 |
| | 250 | 0.25 | 10/0 | 10/0 | 10/0 | 10/0 | — | 100 |
| | 500 | 0.5 | 10/0 | 10/0 | 10/0 | 10/0 | — | 100 |
| UTC | 0 | 0 | 0/10 | 0/10 | 0/10 | 0/10 | — | 0 |
| A + B | 100/100 | 0.1/0.1 | 9/1 | 9/1 | 8/2 | 5/5 | 43.9 | 77.5 |
| 1:1 ratio | 250/250 | 0.25/0.25 | 10/0 | 10/0 | 10/0 | 10/0 | 100 | 100 |
| | 500/500 | 0.5/0.5 | 10/0 | 10/0 | 10/0 | 10/0 | 100 | 100 |
| UTC | 0 | 0 | 0/10 | 0/10 | 0/10 | 0/10 | — | 0 |
| A + B | 100/50 | 0.1/0.05 | 7/3 | 7/3 | 6/4 | 6/4 | 24.4 | 65 |
| 2:1ratio | 200/100 | 0.2/0.1 | 9/1 | 10/0 | 9/1 | 9/1 | — | 92.5 |
| | 400/200 | 0.4/0.2 | 10/0 | 10/0 | 10/0 | 10/0 | — | 100 |

A is bifenthrin
B is fipronil
Bold numbers indicate synergistic effect in control

In order to compare the pesticidal effectiveness of the individual and combination treatments the LC 50 and LC 90 values (lethal concentration in ppm that would effectively knock down/kill 50% or 90% of the test pests) were calculated. In calculating the LC values for the various mixtures of bifenthrin and fipronil, probit analysis was conducted on the fipronil concentration of the mixture. For example, if the amount of fipronil predicted to kill 90% (i.e. LC 90) of the cockroaches was 84 ppm in a 2:1 ratio of bifenthrin to fipronil, 168 ppm of bifenthrin would be in the 2:1 mixture. The values calculated from the data of Table 1 are in Table 1A below.

TABLE 1A
LC 50 and LC 90 Values for Cockroach by Application
of Combinations of Bifenthrin and Fipronil

| Treatment | LC 50 (ppm) | LC 90 (ppm) |
|---|---|---|
| Bifenthrin | 193 | 301 |
| Fipronil | 102 | 179 |
| Bifenthrin + Fipronil | 75:75 | 134:134 |
| 1:1 | | |
| Bifenthrin + Fipronil | 90:45 | 168:84 |
| 2:1 | | |

As can be seen from the LC 50 and LC 90 values in Table 1A, much less, of the active ingredients are needed when combined in a 2:1 or 1:1 bifenthrin to fipronil ratio to control German cockroach as compared to the active ingredients alone.

### Example 2

### Test 2 to Determine Cockroach Mortality Rates by Applications of Combinations of Bifenthrin and Fipronil

The compositions of the present invention were tested for American cockroach (Periplaneta americana) activity in the following manner:

Test solutions were made by dissolving technical grade bifenthrin and fipronil in acetone to provide appropriate rates of application of bifenthrin and fipronil alone, as well as combinations of bifenthrin and fipronil. The active ingredient concentrations tested were from 10 part per million (0.01 mg of active ingredient/mL or 0.01 g/L) to 1000 parts per million (1.0 mg of active ingredient/mL or 1.0 g/L), four replicates per rate. In a fume cabinet, one milliliter of a test solution was applied to a 9 cm Whatman® 2 qualitative filter paper using a calibrated pipette. The application started at the center of the filter paper with individual drops being applied in an outward circular motion so that the entire filter paper was uniformly treated. Acetone only (one mL) was applied in the same manner to provide an untreated control (UTC). The treated filter papers were allowed to dry for two hours. The dried, treated or untreated filter paper was placed into a plastic cup having a base diameter of 90 mm, in which the upper portion of the walls of the plastic cup were coated with a fluoropolymer resin (PFTE-30) insect barrier (Fluoron® available from BioQuip Products Inc.) to prevent the insects from climbing out of the container. Ten late instar, healthy and active American cockroaches (Periplaneta americana) were momentarily immobilized using carbon dioxide and then placed onto the filter paper. The top of the plastic containers were covered with gauze to contain the cockroaches. The plastic containers were maintained at a temperature of 25° C. to 30° C. at ambient relative humidity out of direct sunlight. American cockroach mortality was assessed after 24 hours by counting the number of alive and the number of knocked down/dead cockroaches. The results are presented in Table 2 below:

TABLE 2
Mortality of Cockroach by Application of Combinations of Bifenthrin and Fipronil

| | Rate of | Rate of | Mortality | Mortality | Mortality | Mortality | % | % |
|---|---|---|---|---|---|---|---|---|
| | Appln. | Appln. | Rep 1 | Rep 2 | Rep 3 | Rep 4 | Expected | Observed |
| Treatment | (ppm) | (mg/mL) | dead/alive | dead/alive | dead/alive | dead/alive | Control | Control |
| UTC | 0 | 0 | 0/10 | 0/10 | 0/10 | 0/10 | — | 0 |
| A | 100 | 0.1 | 1/9 | 0/10 | 0/10 | 0/10 | — | 2.5 |
| Bifenthrin | 125 | 0.125 | 1/9 | 10/0 | 7/3 | 0/10 | — | 45 |
| | 200 | 0.2 | 0/10 | 0/10 | 0/10 | 4/6 | — | 10 |
| | 250 | 0.25 | 1/9 | 1/9 | 2/8 | 1/9 | — | 12.5 |
| | 400 | 0.4 | 1/9 | 2/8 | 4/6 | 2/8 | — | 22.5 |
| | 500 | 0.5 | 0/10 | 5/5 | 2/8 | 3/7 | — | 25 |
| | 1000 | 1.0 | 10/0 | 10/0 | 10/0 | 9/1 | — | 97.5 |
| UTC | 0 | 0 | 0/10 | 0/10 | 0/10 | 0/10 | — | 0 |
| B | 10 | 0.01 | 0/10 | 0/10 | 0/10 | 0/10 | — | 0 |
| Fipronil | 20 | 0.02 | 0/10 | 0/10 | 0/10 | 0/10 | — | 0 |
| | 25 | 0.025 | 0/10 | 0/10 | 0/10 | 0/10 | — | 0 |
| | 50 | 0.05 | 0/10 | 0/10 | 0/10 | 0/10 | — | 0 |
| | 100 | 0.1 | 0/10 | 0/10 | 0/10 | 1/9 | — | 2.5 |
| | 125 | 0.125 | 0/10 | 0/10 | 0/10 | 1/9 | — | 2.5 |
| | 200 | 0.2 | 0/10 | 0/10 | 1/9 | 0/10 | — | 2.5 |
| | 250 | 0.25 | 0/10 | 8/2 | 7/3 | 3/7 | — | 45 |
| | 500 | 0.5 | 1/9 | 8/2 | 5/5 | 4/6 | — | 45 |
| UTC | 0 | 0 | 0/10 | 0/10 | 0/10 | 0/10 | — | 0 |
| A + B | 100/100 | 0.1/0.1 | 2/8 | 3/7 | 2/8 | 4/6 | 4.9 | 27.5 |
| 1:1 | 125/125 | 0.125/0.125 | 9/1 | 6/4 | 3/7 | 4/6 | 46.4 | 55 |
| Retio | 250/250 | 0.25/0.25 | 10/0 | 9/1 | 10/0 | 9/1 | 51.9 | 95 |
| | 500/500 | 0.5/0.5 | 10/0 | 10/0 | 10/0 | 10/0 | 58.8 | 100 |
| UTC | 0 | 0 | 0/10 | 0/10 | 0/10 | 0/10 | — | 0 |
| A + B | 100/50 | 0.1/0.05 | 2/8 | 0/10 | 0/10 | 1/9 | 2.5 | 7.5 |
| 2:1 | 125/62.5 | 0.125/0.0625 | 0/10 | 0/10 | 0/10 | 0/10 | — | 0 |
| Ratio | 250/125 | 0.25/0.125 | 4/6 | 10/0 | 7/3 | 4/6 | 14.7 | 62.5 |
| | 500/250 | 0.5/0.25 | 10/0 | 7/3 | 10/0 | 10/0 | 58.8 | 92.5 |
| UTC | 0 | 0 | 0/10 | 0/10 | 0/10 | 0/10 | — | 0 |
| A + B | 100/20 | 0.1/0.02 | 1/9 | 5/5 | 1/9 | 0/10 | 2.5 | 17.5 |
| 5:1 | 250/50 | 0.25/0.05 | 10/0 | 8/2 | 10/0 | 6/4 | 12.5 | 85 |
| Ratio | 500/100 | 0.5/0.1 | 10/0 | 10/0 | 10/0 | 10/0 | 25 | 100 |
| | 1000/200 | 1.0/0.2 | 10/ | 10/0 | 10/0 | 10/0 | 97.5 | 100 |
| UTC | 0 | 0 | 0/10 | 0/10 | 0/10 | 0/10 | — | 0 |
| A + B | 100/10 | 0.1/0.01 | 0/10 | 1/9 | 1/9 | 7/9 | 2.5 | 22.5 |
| 10:1 | 250/25 | 0.25/0.025 | 10/0 | 10/0 | 10/0 | 10/0 | 12.5 | 100 |
| Ratio | 500/50 | 0.5/0.05 | 10/0 | 10/0 | 10/0 | 10/0 | 85 | 100 |
| | 1000/100 | 1.0/0.1 | 10/0 | 10/0 | 10/0 | 10/0 | 97.5 | 100 |

A is bifenthrin
B is fipronil
Bold numbers indicate synergistic effect in control

In order to compare the pesticidal effectiveness of the individual and combination treatments the LC 50 and LC 90 values (lethal concentration in ppm that would effectively knock down/kill 50% or 90% of the test pests) were calculated. In calculating the LC values for the various mixtures of bifenthrin and fipronil, probit analysis was conducted on the bifenthrin in concentration of the mixture. For example, if the amount of bifenthrin predicted to kill 90% (i.e. LC 90) of the cockroaches was 418 ppm in a 2:1 ratio, this would include 209 ppm of fipronil. The values calculated from the data of Table 2 are in Table 2A below.

TABLE 2A
LC 50 and LC 90 Values for Cockroach by Application
of Combinations of Bifenthrin and Fipronil

| Treatment | LC 50 (ppm) | LC 90 (ppm) |
|---|---|---|
| Bifenthrin | 906 | 1618 |
| Fipronil | 1013 | 1742 |
| Bifenthrin + Fipronil | 134:134 | 206:206 |
| 1:1 | | |
| Bifenthrin + Fipronil | 275:138 | 418:209 |
| 2:1 | | |
| Bifenthrin + Fipronil | 229:45.8 | 390:78 |
| 5:1 | | |
| Bifenthrin + Fipronil | 128:12.8 | 176:17.6 |
| 10:1 | | |

As can be seen from the LC 50 and LC 90 values in Table 2A, much less of the active ingredients are needed when combined in a 10:1 to 1:1 bifenthrin to fipronil ratio to control American cockroach as compared to the active ingredients alone.

### Example 3

### Determination of Spider Mortality Rates by Applications of Combinations of Bifenthrin and Fipronil

The compositions of the present invention were tested for black house spider (Badumna insignis) activity in the following manner:

Formulations of the test compounds were made as follows:
1). Fipronil—a suspension concentrate formulation containing 100 g/L fipronil as the active ingredient was prepared.
2) Bifenthrin—a commercially available suspension concentrate formulation of bifenthrin containing 100 g/L bifenthrin as the active ingredient was used, Biflex® Aquamax Insecticide, available from FMC Australasia Ply Ltd.
3) Bifenthrin/fipronil premix 1—a suspension concentrate formulation containing 105.6 g/L bifenthrin and 111.5 g/L fipronil as the active ingredients was prepared.
4) Bifenthrin/fipronil premix 2—a suspension concentrate formulation containing 101.3 g/L bifenthrin and 47.9 g/L fipronil as the active ingredients was prepared.

The testing was conducted on pine plywood surfaces that had dimensions of 20 cm×20 cm. The above formulations were diluted in water to achieve the desired concentration rate in grams of active ingredient per liter prior to application to the pine plywood. Each treatment was applied using an airbrush sprayer and compressed air as the propellant. The equipment was calibrated prior to use and the treatments were applied to the pine plywood surfaces at a rate of 1 L/10 m² (4 mL of final test solution per 20 cm×20 cm pine plywood surface)'. For example, in order to obtain a application rate of 0.125 gram of active ingredient per 10 m², 1.25 mL of the fipronil formulation 1) which contained 100 gram per liter suspension concentrate formulation of fipronil, was diluted in 1 liter of water to make a final test solution. Four mL of the final test solution was sprayed onto the pine plywood surface. The treated pine plywood was allowed to air dry at ambient temperature by storing horizontally away from direct sunlight. Three black house spiders, medium to large in size collected from the field 1 to 2 days prior to testing, were placed separately under untreated portion cups (7 cm diameter by 7 cm deep) on the treated pine plywood surfaces. The untreated portion cups provided an opportunity for the spiders to seek an untreated area. The spiders were assessed after 24 hours exposure by counting the number of alive and the number of knocked down/dead spiders. There were three replications of each treatment. The results were averaged and are presented in Table 3 below:

TABLE 3
Percent Mortality of Spiders by Application of Combinations
of Bifenthrin and Fipronil

| | | Test Solution | | |
|---|---|---|---|---|
| | | Concentration Rate | Expected | Observed |
| | Test Solution | g ai/L | % Control | % Control |
| 1) | Fipronil | 0.125 | — | 0.0 |
| 1) | Fipronil | 0.25 | — | 0.0 |
| 1) | Fipronil | 0.5 | — | 0.0 |
| 2) | Bifenthrin | 0.25 | — | 88.9 |
| 2) | Bifenthrin | 0.5 | — | 88.9 |
| 3) | Premix 1* | 0.25/0.25 | 88.9 | 100.0 |
| 3) | Premix 1* | 0.5/0.5 | 88.9 | 100.0 |
| 4) | Premix 2* | 0.25/0.125 | 88.9 | 100.0 |
| 4) | Premix 2* | 0.5/0.25 | 88.9 | 100.0 |
| | Untreated Control | 0 | — | 0.0 |

*Concentration Rate is bifenthrin/fipronil
Bold numbers indicate synergistic effect in control

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method for the control of cockroaches or spiders which comprises applying to a locus where cockroach or spider control is needed or expected to be needed a synergistically effective amount of a combination of bifenthrin and fipronil.

2. The method of claim 1, wherein the bifenthrin and fipronil are present at a weight to weight, ratio of from about 10:1 to about 1:1 wherein at least about 100 ppm of bifenthrin is employed.

3. The method according to claim 2, wherein said cockroach is selected from German cockroach and American cockroach.

4. The method according to claim 2, wherein said locus is selected from a pest-infested structure, a structure that is expected to be pest-infested, or a location adjacent to these structures.

5. A method for the control of spiders which comprises applying a synergistically effective amount of bifenthrin and a synergistically effective amount of fipronil either together or sequentially, in any order, to a locus where spider control is needed or expected to be needed wherein the weight ratio of bifenthrin to fipronil is from about 2:1 to about 1:1.
